(19) United States
(12) Patent Application Publication
(10) Pub. No.: US 2007/0150427 A1
(43) Pub. Date: Jun. 28, 2007

(54) Recognition plan/goal abandonment

(75) Inventor: Christopher W. Geib, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/317,461

(22) Filed: Dec. 22, 2005

(51) Int. Cl. G06N 5/00

(52) U.S. Cl. 706/45

(57) ABSTRACT

A plan recognition model is arranged to recognizing a plan based on observed actions as contained in an audit log. An audit log containing a collection of observed actions of at least one agent is read, and the observed actions contained in the audit log are compared to plan actions contained in plans stored in a plan library. Explanations for the observed actions are generated based on the comparison of the observed actions to plan actions, and at least one of the explanations is selected as a best fit for the observed actions. The selected explanation is provided as an output.

### TECHNICAL FIELD OF THE INVENTION

The present invention relates to the recognition of events in previously recorded audit logs and/or the like. The present invention may be used, for example, to determine conduct of interest regarding the use of a computer by investigating logs of past behavior. Applications of the present invention include everything from assistive systems for the elderly, to computer network security, to insider threat detection, to agent based systems, etc.

### BACKGROUND OF THE INVENTION

Security measures such as firewalls, cryptography, intrusion detection, network management, and passwords have been used in an attempt to make computer systems more resistant to unauthorized access. But even with these measures, computer systems remain vulnerable and can be exploited by hackers as well as by insiders who have legitimate access to at least portions of the computer systems. For example, insiders (who may include authorized users) are currently able to do largely as they please, and outsiders (such as hackers) can slip through the vulnerabilities in the security measures currently in use to gain authorization. The list of vulnerabilities of computer systems is large and growing.

In order to mitigate these vulnerabilities, various commercial-off-the-shelf software packages have been developed. These packages typically place security as a distinctly secondary goal behind the goals of power and convenience. There is also a trend that relates to the software monoculture typified by attempts at software standardization. However, while it is easier to manage training and installation when all of the nodes of a system are identically configured, this node standardization amplifies the risk of unauthorized access. If one node in the system is susceptible to some vulnerability, nearly all of the nodes in the system are likewise susceptible. The success of viruses and worms in bringing corporate networks to a standstill is a recurring demonstration of this weakness.

Many systems warrant a further layer of security. Security systems currently exist that, in a rudimentary way, predict likely outcomes of user commands. These security systems use physical (or other) models to reason out the effect of certain commands on a protected asset. For example, mathematical models are currently used in “power system security” analysis. That is, the operator of an electric power grid may use a mathematical model of load, power generation, voltage, and current everywhere over the power grid to make sure that planned changes will leave the grid in a stable safe state, even if one or more faults occur. Thus, before a proposed power transfer from point A to point B is implemented, the model simulates various possible line outages that could occur in order to make sure that, in spite of such outages (or planned transfers), the power grid will remain in a stable state (no overloads, blackouts, etc.). A basic reference on this topic is a text entitled “Power Generation, Operation and Control”, by Allen Wood and Bruce Wollenberg.

For the most part, current computer systems promptly obey any commands issued by the last authenticated operator so long as the commands fall within the privileges granted. Even when a system attempts to predict outcomes of user actions, such systems are not fully integrated so as to anticipate future commands of a user and to consider a range of responses dependent on the level of the threat of future commands.

A plan recognition system can be developed that increases the level of protection afforded against unauthorized entry and/or use by recognizing the goal or goals of an agent and by taking appropriate action.

Much early work on plan recognition made simplifying assumptions such as an observed agent pursues only a single plan at a time, an observed agent's actions are completely observable, no conclusions can be drawn from failing to see an action, an observed agent never abandons plans, actions within a plan have no explicit temporal relations, and observations are limited and propositional. These assumptions are too restrictive for a plan recognition system to be effectively applied to many domains.

For example, many plan recognition systems have made the assumption of a single agent, who pursue a single goal, and who is not actively hostile to others attempting to infer the plans of the agent. This assumption has left a number of issues unexplored. For example, it is assumed in much early work that the actions of the agent are fully observable. However, in adversarial situations, agents attempt to mask their actions in order to make the inference of their goals harder. Some previous approaches to plan recognition ignore the question of what can be inferred from missing observations. Missing observations, however, are important to many adversarial domains. Further, an agent need not engage in only a single task at a time. Often agents have multiple concurrent and interleaved plans for different goals.

Two kinds of plan recognition, keyhole and intended plan recognition, have been distinguished in the literature. In keyhole recognition, the recognizer is simply watching normal actions by an ambivalent agent. In intended plan recognition, the agent is cooperative and the agent's actions are done with the intent that they be understood. In neither case is the agent actively hostile to the process of plan recognition, which has led to assumptions that limit the useful of such systems.

Early plan recognition systems were rule-based using inference rules that capture the nature of plan recognition. It was then suggested that plan recognition should be a specific form of the general problem of abduction (reasoning to the best explanation). In 1986, H. Kautz and J. F. Allen, in “Generalized plan recognition,” Proceedings of the Conference of the American Association of Artificial Intelligence (AAAI-86), pp. 32-38 defined the problem of keyhole plan recognition as the problem of identifying a minimal set of top-level actions sufficient to explain a set of observed actions. Plans were represented in a plan graph, with top-level actions as root nodes and expansions of these actions into unordered sets of child actions representing plan decomposition. Accordingly, plan recognition was equivalent to graph covering. The model of plan recognition proposed by Kautz and Allen treated plan recognition as a problem of computing minimal explanations in the form of vertex covers based on the plan graph. A significant problem with the work of Kautz and Allen is that it does not take into account differences in the a priori likelihood of different plans.

It has also been asserted that, since plan recognition involves abduction, plan recognition could best be accomplished as a Bayesian (probabilistic) inference. Bayesian inference supports the preference for minimal explanations, in the case of hypotheses that are equally likely, but also correctly handles explanations of the same complexity but different likelihoods.

Neither of these approaches to plan recognition take into account the failure to observe certain actions. To do so presents a complex problem. For example, given the plan library of FIG. 1, if the observed actions are consistent with the actions of scan and get-ctrl and if it is assumed that the a priori probabilities of these actions are the same, a plan recognition system should conclude that Brag and Theft are equally good explanations for these actions. However, as time goes by, if the plan recognition system observes other actions without observing actions that contribute to get-data, the plan recognition system should become more and more certain that Brag rather than Theft is the right explanation.

Prior systems are not capable of this sort of reasoning because they do not consider plan recognition as a problem that evolves over time and they do not consider actions that are not observed.

M. Vilain, in “Deduction as Parsing,” Proceedings of the Conference of the American Association of Artificial Intelligence (1991), pp. 464-470, 1991, presented a theory of plan recognition involving parsing based on the theory of Kautz and Allen. The major problem with parsing as a model of plan recognition is that parsing does not properly treat partially-ordered plans or interleaved plans. Both partial ordering and plan interleaving result in an exponential increase in the size of the required grammar to parse.

More recently, Pynadath and Wellman, in “Probabilistic State-Dependent Grammars for Plan Recognition,” Proceedings of the Conference on Uncertainty in Artificial Intelligence (UAI-'00), pp. 507-514, 2000, proposed a plan recognition schema that is both probabilistic and parsing based. They represent plan libraries as probabilistic context-free grammars and extract Bayesian networks from the probabilistic context-free grammars to interpret observation sequences. Unfortunately, this approach suffers from the same limitations on plan interleaving as Vilain's. Wellman and Pynadath suggest that probabilistic context-sensitive grammars might overcome this problem. However, it is difficult to define a probability distribution for a probabilistic context-free grammar.

Keyhole plan recognition has been suggested for coordinating teams of Procedural Reasoning System (PRS) based agents. Belief networks are automatically generated for plan recognition from PRS knowledge areas (hierarchical reactive plans). However, the generated belief networks for real world problems are too complex for efficient reasoning. It is simpler to work with the plan representation directly. Further, it is not clear how this schema can handle the interleaving of multiple plans and the development of plans over time.

H. H. Bui, S. Venkatesh, and G. West, in “Policy Recognition in the Abstract Hidden Markov Model,” Technical Report 412000 School of Computer Science, Curtin University of Technology, 2002 have proposed a model of plan recognition based on a variant of hidden Markov models. While this model does base its model on plan execution over time, it does not address the case of multiple goals. Like Wellman and Pynadath, the Bui model has to define a probability distribution over the set of all possible root goal sets in order to address multiple concurrent root goals.

Thus, to effectively address plan recognition in adversarial domains, the assumption that the observed agents will be amenable to observation and inference must be discarded, and the order in which actions are executed must be understood in order to understand and determine when an agent has multiple goals. Thus, a model of plan execution is needed in which it is recognized that goal driven agents take those actions that are consistent with their goals and that are enabled by the actions that they have already taken. The set of actions that an agent could execute next, given their goals, and the actions they have already performed are referred to herein as the pending set. Pending sets may be used by a probabilistic algorithm to recognize plan execution.

Further, a plan recognition system should recognize when the agent has abandoned one or more goals. If a plan recognition system is unable to recognize goal abandonment, the plan recognition system will build up an ever increasing set of active or open (pending) plans that the agent has no intention of completing. A system attempting to find completions for these open plans will consider an unreasonable number of situations that would slow down the recognition of the goals not abandoned.

Plan recognition and related systems including those that recognize goal abandonment are disclosed in the following applications: application Ser. No. 10/286,398 filed Nov. 1, 2002; application Ser. No. 10/303,223 filed Nov. 25, 2002; application Ser. No. 10/339,941 filed Jan. 10, 2003; application Ser. No. 10/341,355 filed Jan. 10, 2003; application Ser. No. 10/348,264 filed Jan. 21, 2003; application Ser. No. 10/444,514 filed May 23, 2003; application Ser. No. 10/703,097 filed Nov. 6, 2003; application Ser. No. 10/703,709 filed Nov. 6, 2003; and, application Ser. No. 10/830,539 filed Apr. 23, 2004. All of these applications are herein incorporated by reference.

One or more of the systems described or referred to above utilize an observation stream as the input to the plan recognition system. These systems are on-line systems that infer plans from current activities of the observed agent. However, there are many instances in which it is desirable to use previously collected audit logs as the observation stream and to infer the execution of plans/events of interest that have happened in the past. For example, an authorized insider may improperly use information in a database in a way that is not detectable unless the users over-arching plan is known. For example, many companies consider their internal phone directories to be proprietary information and that giving this information to outsiders is improper. However, use of the phone directory is required to perform most tasks within a company. One could imagine that printing a single page of a company's online phone directory is not unusual or wrong, but printing the whole directory might suggest that an authorized insider plans to improperly give the directory to someone else. In this case, the only practical way to detect such improper activities may be to analyze audit logs from the computers and/or printers with a plan recognition system.

Accordingly, the present invention in one embodiment is related to a probabilistic plan recognition model that is used to analyze audit logs in order to determine plans and/or goals of agents.

### SUMMARY OF THE INVENTION

In accordance with one aspect of the present invention, a plan recognition method, implemented by a processing system, of recognizing a plan based on observed actions as contained in an audit log comprises the following: reading an audit log containing a collection of past observed actions of at least one agent; based on the observed actions contained in the audit log and a plan library, repeatedly interleaving generation of a pending set of actions that are pending execution by the agent and generation of explanations for the pending actions contained in the pending set; computing probabilities as to the likelihood that the explanations represent at least one actual plan of the agent; and, recognizing at least one of the explanations as the actual plan of the agent based on the computed probabilities.

In accordance with another aspect of the present invention, a plan recognition method, implemented by a processing system, of recognizing a plan based on observed actions as contained in an audit log comprises the following: reading an audit log containing a collection of observed actions of at least one agent; comparing the observed actions contained in the audit log to plan actions contained in plans stored in a plan library; generating explanations for the observed actions based on the comparison of the observed actions to plan actions; selecting at least one of the explanations as a best fit for the observed actions; and, providing an output based on the selected explanation.

In accordance with yet another aspect of the present invention, a computer readable storage medium have program code stored thereon which, where executed, performs the following plan recognition functions: reading an audit log containing a collection of observed actions of at least one agent; comparing the observed actions contained in the audit log to plan actions contained in plans stored in a plan library; generating explanations for the observed actions based on the comparison of the observed actions to plan actions; computing probabilities as to the likelihood that the explanations represent at least one actual plan of the agent; based on the computed probabilities, selecting at least one of the explanations as a best fit for the observed actions; and, providing an output based on the selected explanation.

### BRIEF DESCRIPTION OF THE DRAWINGS

These and other features and advantages will become more apparent from a detailed consideration of the invention when taken in conjunction with the drawings in which:

FIG. 1 illustrates an example of a set of plans that may be stored in a plan library of a plan recognition system;

FIG. 2 illustrates the generation of pending sets of actions related to plans in the plan library;

FIG. 3 shows substitution of a new tree for a non-terminal node in an existing tree;

FIG. 4 shows one possible explanation for the sequence of observations (zt,t1), (ips,t2), (zt,t3), (ps,t4), (pod,t5) given the plan library shown in FIG. 1;

FIG. 5 illustrates a model of plan execution and pending set generation with abandoned goals;

FIG. 6 illustrates a very simple example plan library useful, in describing the present invention:

FIG. 7 shows a plan recognition system in accordance with an embodiment of the present invention; and,

FIG. 8 shows a flow chart of a program that can be executed by the plan recognition system of FIG. 7 in order to explain observed actions.

### DETAILED DESCRIPTION

The plan recognition system described herein is based on a model of the execution of hierarchical plans rather than of plans as formal models of syntactic entities. This different modeling approach gives rise to different intuitions about how plans should be recognized. Plan recognition algorithms typically require as an input a set of plans that are to be recognized. Example formal definitions for such plans are provided below, although for purposes of discussion it is convenient to discuss such plans with a less formal representation as partially ordered “and/or” trees having “and nodes” and “or nodes,” where the children of the “and nodes” may be partially ordered.

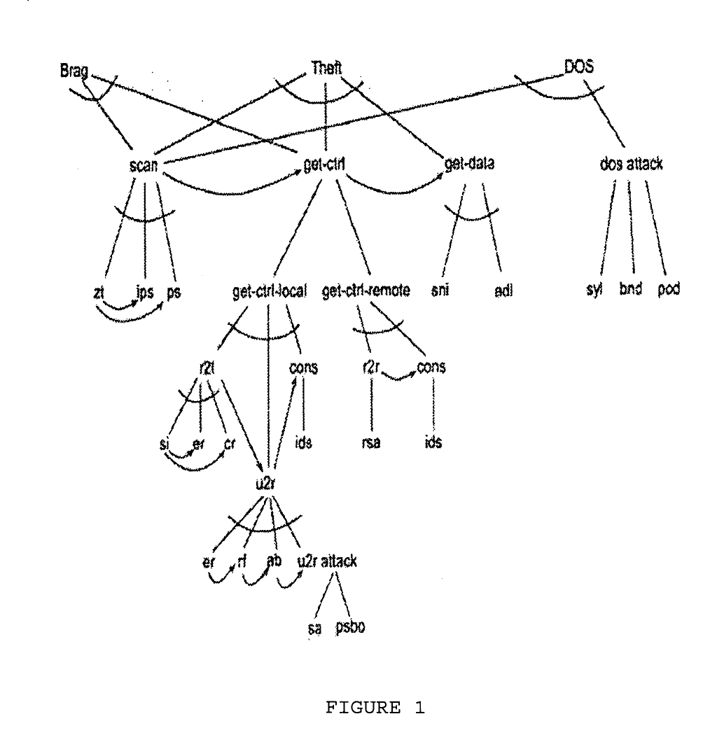

As an example, FIG. 1 displays a simplified set of hierarchical plans taken from a computer network security domain. The trees of FIG. 1 define a decomposition of root goals (Brag, Theft, Denial of Service) into sequences of sub-actions that will achieve the root goals. Such a decomposition is indicated in FIG. 1 by a straight solid line from a parent node to each of its children nodes. If all of the sub-actions must be done to achieve the parent goal, the parent goal is represented as an “and node” in the tree, and is illustrated in FIG. 1 by an arc crossing all of the links from the parent to the children. In many cases, the sub-steps of an “and node” must be done in a particular order. Ordering constraints between the actions necessary to achieve a goal are represented by directed arcs (arcuate arrows) in the plan graph of FIG. 1. Certain actions of a particular plan graph may not be ordered with respect to each other. If the sub-actions are alternative sub-actions, the parent goal is represented as an “or node” in the tree, and is illustrated in FIG. 1 by no arc crossing the links from the parent to the children.

According to this simplified set of hierarchical plans shown in FIG. 1, the agent (in this case an attacker) is motivated by one of three top-level goals: bragging (Brag: being able to boast of his/her success to other crackers); theft of information (Theft); or denial of service (DoS: attacking a network by consuming its resources so that it can no longer serve its legitimate objectives).

Attackers who wish to achieve bragging rights will first scan the target network for vulnerabilities (scan), and then attempt to gain control (get-ctrl). They are not motivated by exploiting the control they gain. On the other hand, attackers who wish to steal information will scan for vulnerabilities, get control of the target, and then exploit that control to steal data (get-data). Finally, an attacker who wishes to deny service (DoS) to users of a host need only scan to identify a vulnerability and then carry out the DoS attack (dos-attack).

FIG. 1 contains a simple plan for scanning. First, a Domain Name Service (DNS) zone transfer (zt) is requested to identify IP addresses in the targeted network. Then an IP sweep (ips) of the detected addresses and a port sweep (ps) are made in no particular order.

The next step is for the attacker to gain control of the host (i.e., to achieve privileged (“root”) access to that host) in order to be able to execute administrative commands. Attackers may attack either remotely (get-ctrl-remote) or locally (get-ctrl-local). The remote attack is simpler, consisting only of a remote to root (r2r) exploit which is an exploit that allows an attacker who is not directly logged into a host to fool that host into being accorded root privilege. While such attacks are simpler, the underlying exploits are less common, because they rely on flaws in network server software. Only one r2r attack is shown in FIG. 1, i.e., remote sadmind attack (rsa). This exploit is followed by consolidating (cons) the attacker's advantage by turning off the local intrusion detection systems (ids).

Attacking locally, i.e., get-ctrl-local, is more complicated, since the attacker must first gain local access (login) from his/her original remote location (r2l), escalate his unprivileged access to root level (u2r), and consolidate his position, in that order. In this case, the r2l attack is an IP masquerading attack. An IP masquerading attack is an attack in which the attacker makes the attacker's computer “masquerade” as a trusted host while connecting to the target. To successfully carry out this masquerade, the trusted host being impersonated is suppressed with a DoS attack (si) followed by corruption of an rhost file (cr) and an external rlogin (er) in either order.

In the escalating privilege step (u2r), the plan captures the possibility that an attacker might download the source for an attack and compile it locally. In this plan, the cracker logs in (er), then uses the FTP protocol to transfer source code for an exploit that will run locally (rf), then builds the exploit application (ab), and finally performs the actual attack using the exploit application (u2rattack). Only two of the possible u2rattack expansions are identified here: an sadmindex attack (sa) and ps buffer overflow (psbo).

In the case of a dos-attack, three of the many possible attacks are identified here: synflood (syl), bind DoS attack (bnd), and the ping of Death (pod).

The plans shown in FIG. 1 include a variety of the phenomena that are of interest for this domain. The plan set reflects both the plans that are of interest as well as specific domain features of interest. However, the domain expert will want to add more plans to this plan library using the structure of FIG. 1, especially as more such plans are experienced and/or envisaged. In any event, this set of plans is sufficient to demonstrate the plan library used by the plan recognition system described herein. It can also be generalized to other domains. Some important features of these plans are that they make use of decomposition (represented by “and nodes”), choice points (represented by “or nodes”), and ordering constraints between sibling actions that represent causal links (represented by arcuate arrows).

Plan recognition as described herein implements a Bayesian approach that relies on a stochastic model that describes how a set of observations are generated from causal variables, and that is then “inverted” to go from observations to hypotheses about underlying causes. In the case of plan recognition, this procedure amounts to providing a stochastic model of plan execution and then “inverting” that model to do plan inference.

The plan recognition model described herein realizes that plans are executed dynamically and that, as a result, the actions that an agent takes at each time step of a plan depend on the actions that were previously taken. Intuitively, at any moment, the agent may wish to execute any of the actions that will contribute to one of the agent's current goals. However, the agent can only successfully execute those actions that have been enabled by prior execution of predecessor actions in the plan. The set of actions that contribute to the agent's current plans and that are enabled by their previous actions are referred to herein as a pending set. The pending set contains the actions that are “pending” execution by the agent.

A model of plan execution can be built with this idea in mind. First, an agent chooses and/or has a set of goals, and the agent chooses a set of plans to achieve the goals. Before the agent acts, there is a subset of actions in the plan that has no prerequisite actions in the plan. The actions in this subset form the initial pending set for the agent. From this initial set, the agent chooses a first action for execution.

After this action has been performed, the agent's pending set is changed. Some actions may be removed from the pending set (the action that was just executed for example) and other actions may be added to the pending set (those actions that are enabled by the execution of the previous action). The agent will choose a next action from the new pending set and the process of choosing an action and building new pending sets repeats until the agent stops performing actions or finishes all plans.

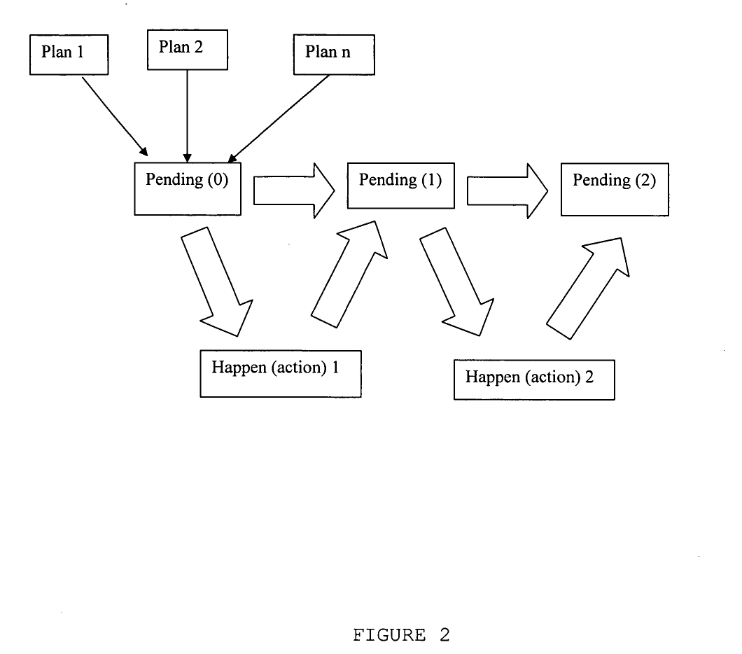

This process is illustrated in FIG. 2 where each action results in a new pending set. If the selection of goals, plans, and actions for execution are probabilistically modeled, the pending sets are a Markov chain and this probabilistic model of plan execution is a hidden Markov model (HMM) because the observer cannot see the agent's goals, choices at the “or nodes” in the plans, or the pending sets.

The process of plan execution can be probabilistically simulated by sampling the agent's goals and plans, and then repeatedly choosing elements from the resulting pending sets, thus generating future pending sets. This approach provides a simple model for the generation of execution traces. For each execution trace, there is a unique corresponding sequence of pending sets.

To use this model to perform probabilistic plan recognition, the observations of the agent's actions are used as execution traces and the generation process is inverted to build an explanation for the observed actions. By hypothesizing goals and plans for the agent, and then stepping forward through the observation trace, a possible pending set trajectory can be generated. As the explanation is built, each observed action is assigned to hypothesized plans that achieve the hypothesized goals of the agent. Thus, the pending set trajectory that is consistent with the observed actions can be determined.

Once the complete set of explanations are built, the probability of each explanation can be computed. Keeping in mind that the plan recognition system utilizes a Bayesian approach, the probability Pr(exp/obs) of a particular explanation exp given a set of observations obs can be computed using Bayes' rule as follows:
Pr(exp ˆ obs)/Pr(obs)
which has the equivalent formulation as follows:

$$Pr ( exp ⋀ obs ) / {\sum }_{i} Pr ( {exp}_{i} ⋀ obs )$$

Specifically, since the probability of a single explanation can be computed, the conditional probability of an explanation and, therefore, the conditional for any particular goal can be computed by building the complete set of possible explanations for the observations, computing their probabilities, and dividing the probability mass associated with those explanations that contain the goal by the probability mass associated with all of the explanations.

A more formal definition for this process can be provided as discussed below. First, explanations and pending sets can be formulated based on a plan library and tree structures in a manner very similar to the definitions for traditional context-free grammars suggested by J. E. Hoperoft and J. D. Ullman, in Introduction to Automata Theory, Languages, and Computation, Addison Wesley, 1979, but extending them to handle partial ordering of actions. In this context, partial ordering of the plans actions means that ordering constraints between the actions are not required. While some of the actions must be done in a specific order with respect to each other, others of the actions may vary in their order. For example, putting on socks must be done before putting on shoes. Thus, putting on socks and shoes are ordered with respect to each other in the higher level action of putting them on. However, if we were buying socks and shoes in the same store, the order in which we picked them out would be unimportant, but would both happen before leaving the store. In this case, picking out the shoes and socks are partially ordered with respect to each other, but are both ordered before the action of leaving the store.

Second, the manner in which probabilities are computed for each of these explanations and conditional probabilities are computed for each goal is described.

The foundation of any plan recognition system is a collection of plans for recognition. These plans can be stored in a plan library and are specified in a formal language as set out in definitions 1-5 below.

Definition 1—A plan library PL is defined as a tuple PL=(Σ, NT, R, P) where Σ is a finite set of basic actions/terminal symbols, NT is a finite set of methods/non-terminal symbols, R is a distinguished subset of “intendable root” non-terminal symbols R ⊂ NT, and P is a set of production rules of the form A→α:φ where
1. A ε NT
2. α is a string of symbols from (Σ ∪ NT)
3. φ={(i,j)|α[i]<α[j]} where α[i] and α[j] refer to the ith and jth symbols in α, respectively.
   Intuitively, this definition is a traditional context-free grammar with the addition of explicit ordering constraints, defined by the relation <, that are added to each of the productions of the grammar to indicate when actions must be performed in a specific order. Traditional context-free grammars assume that ordering of symbols indicates a required ordering in the plan. Thus, in a traditional context-free grammar, partial ordering is represented by replicating those rules that contain partial ordering, one production for each of the possible orderings for the actions. This replication would result in a significant increase in the size of the plan library.

In FIG. 1, the basic actions/terminal symbols correspond to the names given to the leaves in the trees in the plan library. The methods/non-terminal symbols correspond to the names of the “and nodes” and “or nodes.” The productions in this formulation of a plan library correspond to “and nodes” in the plan tree shown in FIG. 1. “Or nodes” in FIG. 1 are captured when there is more than one production for a non-terminal. For example, the productions:
Theft→scan get-ctrl get-data: {(1,2)(2,3)}
scan→ztipsps: {(1,2)(1,3)}
get-ctrl→get-ctrl-local: { }
get-ctrl→get-ctrl-remote: { }
get-data→sniadl: { }
   would capture the first two levels of the plan for Theft shown in FIG. 1 with the two rules for get-ctrl capturing the “or node.”

Definition 2—Given a rule ρ=A→β:φ, β[i] is a leftmost child of A given ρ if [symbol] j such that (j,i) ε φ.

The set of leftmost symbols for a given rule allows those symbols to be first in any expansion of the parent non-terminal by that rule. This definition does not require that there be a unique leftmost symbol of a rule, and the set of such leftmost symbols is denoted as L(ρ) and the set of symbols that are not left most symbols of ρ is denoted as R(ρ).

Definition 3—Given a plan library PL=(Σ, NT, R, P), a leftmost tree T, deriving α, can be defined as a tree such that
1. every node in T is labeled with a symbol from Σ ∪ NT.
2. every interior node in T is labeled with a symbol from NT.
3. if an interior node, n, labeled A in T has children with labels β₁, . . . , βₖ, then
   ∃ρ ε P|ρ=A→β₁, . . . ,βₖ:φ
   node n is additionally annotated with ρ
   no children of n labeled with symbols in R(ρ) have children.
   at most one child of n labeled with a symbol in L(ρ) has children of its own.
4. there is a distinguished node in the frontier of T labeled with the terminal symbol α. This node is the foot of the tree T.

Leftmost trees correspond very closely to minimal, leftmost, depth-first, derivation trees for a specific terminal in traditional context-free grammars. In this case the ordering relation defined for the plan library is used to determine which methods/non-terminals are leftmost. The leftmost trees are used both to build explanations and as elements of pending sets by first defining a generating set of trees for a particular plan library and then defining the process by which the trees are composed to produce explanations of sequences of observations.

Definition 4—A set of leftmost trees is said to be generating for a plan library PL=(Σ, NT, R, P) if it contains all of the leftmost trees that derive some basic action in Σ rooted at a method in NT. The generating set is denoted as G(PL) and its members are denoted as generating trees.

Substitution is used to combine the trees in the generating set to build larger trees. Substitution is the process whereby a frontier non-terminal in an existing tree is replaced with a leftmost tree that is rooted with the same non-terminal symbol while obeying the ordering constraints defined by the plan library.

Definition 5—Given a tree Tᵢₙᵢₜ with a frontier, non-terminal node m, and assuming node n to be m's parent node, and assuming without loss of generality that n is labeled A and is annotated with the rule A→β₁, . . . ,βₖ:φ and that m is labeled βᵢ, and further given a leftmost tree whose root is labeled with βᵢ and is denoted T_{βi}, T_{βi} can be substituted for m in Tᵢₙᵢₜ resulting in Tᵣₑₛ just in the case that, ∀j,i|(j,i) ε φ, the frontier of the subtree of Tᵢₙᵢₜ rooted at n's child labeled βⱼ only contains terminal symbols, and that Tᵣₑₛ is the tree that is obtained by replacing βᵢ by T_{βi}.

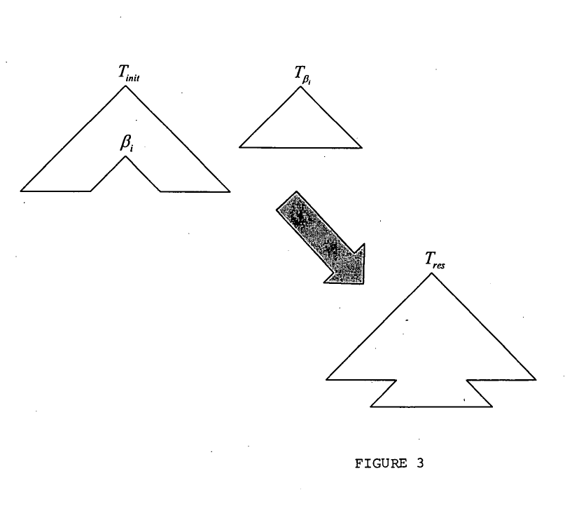

FIG. 3 shows an abstract example of substitution in graphical form where T_{βi} is substituted for a node in Tᵢₙᵢₜ to form Tᵣₑₛ.

In order for a new tree T_{βi} to be substituted for a non-terminal node m in an existing tree Tᵢₙᵢₜ, the portion of the frontier of the existing tree Tᵢₙᵢₜ that is required by the plan library PL to precede the substitution site m cannot have non-terminals. That is, the portion of the existing tree's frontier that precedes the substitution site must be completely expanded (contain only terminal symbols/basic actions). This definition of substitution is similar to tree adjunction as presented by A. Joshi and Y Schabes, in “Tree-Adjoining Grammars,” Handbook of Formal Languages, Vol. 3, pp. 69-124, Springer Verlag, 1997, again with the introduction of ordering constraints.

The above definitions 1-5 define a plan library and the tree structures that follow from it. The next two definitions 6 and 7 define pending sets.

Definition 6—The initial pending set PS₀ ⊂ G(PL) is defined such that, PS₀=(∀T ε G(PL) root(T) ε R).

Root(T) denotes the label of the root node of the tree T. Intuitively this set of trees corresponds to those leftmost trees in the generating set that derive an action that could introduce a new plan. That is, these trees all derive the first action of a plan rooted in one of the distinguished intendable root non-terminals. While the initial pending set plays an important role in the discussion herein, all other pending sets are defined as derived from a set of existing trees.

Definition 7—Given a plan library PL and a set of partially expanded trees D representing plans from PL, the pending set for D is defined as the set of all trees T ε G(PL) that can be substituted into some tree in D.

A pending set can contain multiple instances of a given generating tree. This definition 7 does not prevent a particular generating tree from being substituted into multiple points in different (or even the same) tree in D. Therefore, the pending set is required to maintain a separate instance for each generating tree indexed by the tree and non-terminal for which it will be substituted.

It is also worthwhile to note that the initial pending set is a subset of every pending set. Since the next observed action could be the first action of a previously unobserved plan, each of these trees is in every pending set.

Given definitions 1-7, explanations and the process of generating them can be formally defined. Intuitively, an explanation for a set of observations is just a pair that contains a forest of trees representing a plan structure that allows for the assignment of each observation to a terminal symbol, called the derivation trees, and the sequence of pending sets that were used in the production of the particular derivation trees. Definition 8 formulates the process of generating explanations.

Definition 8—An explanation is defined for a sequence of observations, σ₁, . . . ,σₙ, as a pair, <D, {PS₀, . . . , PSₙ₊₁}>, where D is a possibly empty forest of derivation trees, and {PS₀, . . . , PSₙ₊₁} is the series of pending sets derived in the construction of D. In order to actually produce a particular explanation, the following algorithm is specified for generating a new explanation on the basis of an existing explanation. Given an observation σεΣ, a plan library PL, and an explanation Eₙ=<D, {PSo, . . . PSₙ}>, a new explanation Eₙ₊₁ can be generated by executing the following steps:
1. Choose from PSₙ a tree T_{new} that can be substituted into T_{cur} ε D such that the foot of T_{new} matches σ.
2. Substitute T_{new} into T_{cur} resulting in Tᵣₑₛ.
3. Define D′=(D−T_{cur}) ∪ Tᵣₑₛ.
4. Generate the new pending set PSₙ₊₁ for D′.

5. Define Eₙ₊₁=<D′, {PSₒ, . . . , PSₙ, PSₙ₊₁}>Given the algorithm above for building one explanation from another, the algorithm for building an explanation for a sequence of observations can be provided. Given a plan library and a sequence of observations σ₁, . . . ,σₙ, the starting point is an initial explanation E₀ that is made up of an empty set of derivation trees and the initial pending set for the plan library. The explanation generation algorithm is then applied for each of the observations in turn until the complete and covering set of explanations for all of the available observations is generated. The following pseudocode explains this process:

Function BuildExplanations (σ₁,..., σₙ) {

ES = {E₀};

For each observation σ in (σ₁,..., σₙ)

E′ = 0;
For each Eᵢ ε ES st Eᵢ = < D, {PSo, . . . PSn } >

For each T_{new}εPSₙ st the foot of T_{new} = σ

Substitute T_{new} into D resulting in D′;
Update PSₙ resulting in PSₙ₊₁;
ES′ = ES′ ∪ {< D′,{PS₀, . . . , PSₙ, PSₙ₊₁ >}};

End-for;

End-for;
ES = ES′;

End-for;

return ES;}

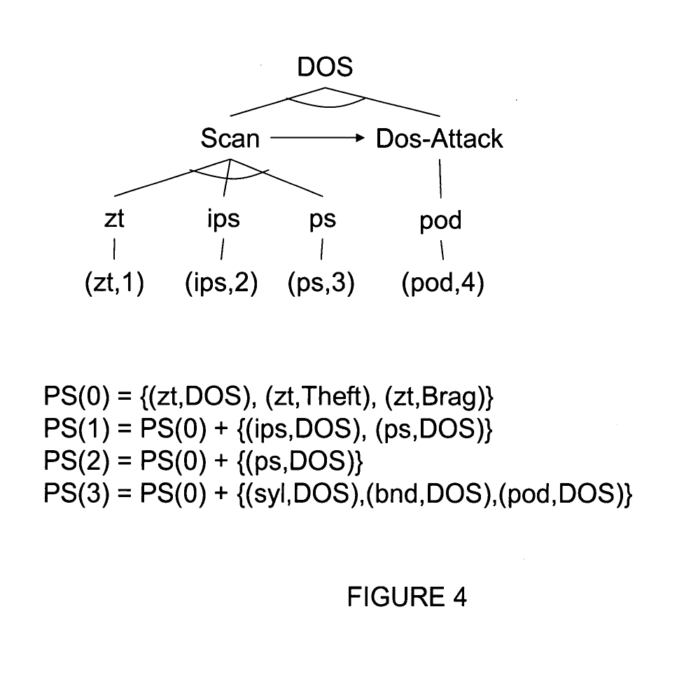

When this algorithm terminates, ES contains the complete set of explanations. For example, given the plan library shown in FIG. 1, one possible explanation for the sequence of observations (zt,t1), (ips,t2), (zt,t3), (ps,t4), (pod,t5) is shown in FIG. 4, where t1, t2, t3, t4, and t5 are sequential instants in time.

The “for” loops require the algorithm to consider all of the possible elements in the pending set of explanations that correspond to the next observation. Thus, if there are multiple elements in the pending set that have the observed action as its leaf, then the search for explanations splits at this point producing one explanation for each of the possible explanations for the observation and adds all of them to the set of explanations ES.

Also, if there are no elements of the current pending set that make use of the observation, then the current explanation is not extended with the observation and is actually removed from the set of explanations. In other words, since there is no explanation for the action, there cannot be a complete and consistent explanation for all of the observations that results from extending this explanation and there is no point in continuing to use it as a basis for explaining the observations.

This algorithm is used to build a complete and covering set of explanations for a set of observations. Then, the probability of each explanation is established. On the basis of these probabilities, the conditional probability that the agent is pursuing any particular goal can be determined.

The probability of an explanation can be computed by considering three kinds of probabilistic features for each of the explanations for the observations.

The first probabilistic feature is the prior probability of each of the root goals being adopted by the actor. This probability is given in the plan library and is represented as Pr (Gᵢ) where i ranges over all the root goals in the explanation.

The second probabilistic feature is related to the choice that the agent has at each “or node” in the plan tree. For each non-terminal/subgoal (“or node”) for which there are multiple production rules, each given rule used to expand the method should have a probability. An “or node” represents a choice for the actor and the plan recognition system should probabilistically model that choice. For example, if a cyber attacker could use a land, synflood, or POD for a denial of service attack, the plan recognition system should have a distribution over how likely each of these possible attacks is given that the agent is going to commit a denial of service attack. Each non-terminal within a plan that has more than one possible rule may be referred to as a choice point.

Typically, it is assumed that each rule is equally likely given its parent goal, if there are J choice points within a given explanation, and if |Chⱼ| represents the number of alternative rules that could be used to expand a particular choice, then 1/|Chⱼ| represents the probability of the agent choosing any particular rule. It should be noted that the assumption that each rule is equally likely given its parent goal is not required by the framework described herein. Any distribution over these choices could be used in place of this assumed uniform distribution.

The third probabilistic feature is the probability for each pending set PS that the observed action is the one chosen next for execution. Again, it may be assumed that all of the actions within the pending set are equally likely. Thus for a particular pending set at time k, the probability of any specific element of the set is given by 1/|PSₖ|. Again, this uniformity assumption is not required, and any distribution could be used. This choice could even be conditioned on the state of the world, hypothesized root goals, and plans of the agent.

Using these three probabilistic features, the prior probability of a given explanation may be computed by multiplying together the prior probabilities for each goal, the probability of the expansion choices, and the probability of the observed actions being chosen. The probabilities corresponding to these three probabilistic features are defined according to Definitions 9-11.

Definition 9—The probability of a given explanation is computed according to the following equation:

$$Pr ( exp , obs ) = {\prod }_{i = 0}^{I} Pr ( {G}_{i} ) {\prod }_{j = 0}^{J} ( \frac{1}{\vert {Ch}_{j} \vert} ) {\prod }_{k = 0}^{K} ( \frac{1}{\vert {PS}_{k} \vert} )$$

where the first term is the probability of the agent's goal set, the second term is the probability that the agent chose the particular plans to achieve the goals, and the final term captures the probability that the given observations occurred in the specified order. As discussed above, Pr(Gᵢ) is the prior probability given in the plan library for the root goal of explanation i for the observed actions of the agent, |Chⱼ| represents the number of alternative rules that could be used to expand a particular one of the J choice points within a given explanation, and PSₖ is the size of the explanation's pending set at time k.

Since, the set of explanations is, by construction, an exclusive and exhaustive covering for the set of observations, these computed probabilities for each explanation can be normalized to yield probabilities for each explanation.

As indicated in Definition 10 below, conditional queries can be computed by summing the probability mass for those explanations that meet the terms of the query and dividing by the total probability mass associated with all explanations that contain the goal.

Definition 10—The probability that an agent intends a particular goal g based on a set of observations is given by the following equation:

$$Pr ( g \vert obs ) = \frac{{\sum }_{e}^{{Exp}_{g}} Pr ( e , obs )}{{\sum }_{e}^{Exp} Pr ( e , obs )}$$

where the denominator sums the probability of all explanations, Exp, for the observations, and the numerator sums the probability of the explanations, Exp_{g}, in which the goal g occurs. A misconception that could be made is that the denominator in this equation should always be one, making this division unnecessary. In fact, the probability mass of the covering set of explanations Exp almost never sums to one as a result of multiple independent root goals and the choices within an explanation.

Other known probabilistic plan recognition systems do not use the three different probabilities discussed above. Most probabilistic context free (and sensitive) grammar (PCFG/PCSG) research has included the use of a single probability for each grammar rule to capture how likely it is that the given non-terminal is expanded using that grammar rule. As a structural relation, this use of a single probability conflates the probabilities that are identified above as the root priors and the choice terms in Definition 9. This use of a single probability also completely leaves out the term for the pending sets, making it impossible for known probabilistic grammars to deal with partial observability, partially ordered plans, and/or multiple concurrent plans.

The plan recognition system described herein can also be arranged to account for the effect of negative evidence (actions that have not been observed). In fact, the use of unobserved actions by the present plan recognition system is a natural consequence of the way in which the probabilities are computed for the pending set term for each explanation.

For example, suppose that there are two explanations for a given set of observations. Further suppose that the set of root goals for one is {A,C}, that the set of root goals for the other is {B,C}, that A is a proper prefix of B, that D represents the suffix of B not in A, and that both explanations have identical assignments of observations to plan actions up until goal A is completed. In terms of the probability that can be computed for each of the two explanations, once the last action in goal A has occurred, the probability that can be computed for the pending set {A,C} must be smaller than the probability that can be computed for the pending set {B,C} because the {A,C} pending set can only have actions for goal C while in the case of the {B,C} the actions that make up goal D are still in the pending set. Based on the uniformity assumption discussed above, the probability computed for the pending set {B,C} decreases each time an action that is not associated with goal D is observed because the pending set size increase with each action.

Of course, if an action consistent with goal D is observed, the explanation must be changed. In the case where observed actions contribute to the goal D, the {A,C} explanation must be ruled out since it cannot explain the action. Thus, the remaining {B,C} explanation, no matter how unlikely, must be correct.

As discussed above, the approach to plan recognition described herein also allows for multiple instances of the same root goal to be active at the same time, which is unusual for plan recognition systems. In fact, many applications do not allow an agent to have more than one goal at a time let alone multiple instances of the same goal. However, for many real world domains, permitting an agent to have only one goal at a time is simply unacceptable.

For example, in the cyber security domain of FIG. 1, it is common for a determined cyber attacker in the real world to launch against a single host multiple different attacks, and even multiple instances of the same attack, all to achieve a single goal. This method of attack is done for a number of reasons: diversity of target susceptibility, attack success likelihood, to create confusion, etc. Thus, in this domain it is very common to see multiple instances of the same goal being pursued by different, very similar, or even identical instances of plans. The explanation presented in FIG. 4 has remained agnostic about the specific Dos-Attack that will be launched (as it should according to the definition of an explanation set out herein). However, since the action zt observed at time t3 is consistent with a second DoS goal, any complete plan recognition algorithm should consider the possibility that there are multiple interleaved instances of this goal being pursued by a single agent at the same time.

Most, if not all, previous work has discounted the possibility that a single agent could be pursuing multiple instances of the same root goal at the same time. However, in many domains of interest, this assumption is simply not valid.

The plan recognition system described herein makes possible a relatively simple treatment of partial observability. All that needs to happen is to extend the model of plan execution with actions that are performed but not observed. This extension requires quantifying the probability that an action was not observed.

First, the probability that the observed agent has actually performed some action, but that the action was not observed, is quantified. Second, a term is added to the formula for computing the probability of a given explanation to capture this probability. Third, the algorithm for generating explanations is modified to eliminate any explanation in which the probability of unobserved actions exceeds a user defined threshold.

It is rare that all observed actions in a domain are equally likely. For example, the U.S. Government is much more likely to be aware of underground testing of a nuclear device than it is to recognize a very slow port scan on one of its computers, even though they have very accurate sensors for both tasks. Relative to the sensors available, some actions are harder to detect than others which, in the literature, is captured by the concept of a “false negative rate” for a given sensor.

This characteristic of the sensor can be learned by watching its long term performance and by noting its failures to report an actual occurrence. Thus, for each possible observed action, the long term false negative rate of an observation stream can be learned and used as the prior probability that the action could be done and not observed. Accordingly, the possibility that an action has been performed and not observed can be explicitly modeled.

There are, however, a number of limitations to this approach. For example, significant changes in the domain or observed agent's capabilities may affect the false negative rates, and will force the plan recognition system to relearn them. During relearning, error will be introduced in the system's probability computations.

Further, for simplicity, the false negative rate can be used as an unconditional prior probability. This false negative rate can be alternatively modeled as a conditional prior probability, and for domains where contextual factors affect the false positive rate, such conditional modeling would be more accurate. This conditional modeling would be a straightforward extension to the plan recognition model, but would increase the computational cost of the resulting algorithm. For this reason, and for simplicity of explanation, modeling the false positive rate as an unconditional prior probability is described herein.

Finally, this modeling does not take into consideration the possibility that the sensor observed the action, but for some other reason failed to report it, such as conditions where there may be communication problems. The modeling described herein takes into consideration the actual failure of the sensor to observe the action.

The following Definition 11 for the probability of a single explanation and observations extends Definition 9 with a final term to explicitly model the probability that all unobserved actions in the explanation are executed and not observed.

Definition 11—The probability of a given explanation as influenced by unobserved actions is computed according to the following equation:

$$Pr ( exp , obs ) = {\prod }_{i = 0}^{I} Pr ( {G}_{i} ) {\prod }_{j = 0}^{J} ( \frac{1}{\vert {Ch}_{j} \vert} ) {\prod }_{k = 0}^{K} ( \frac{1}{\vert {PS}_{k} \vert} ) {\prod }_{l = 0}^{L} ( Pr ( {unobs}_{1} ) )$$

Without loss of generality, Definition 11 assumes that the explanation has L actions that have been performed and not observed and that Pr(unobsₗ) represents the false negative rate for sensing the unobserved action l.

In addition to extending the definition of the probability of an explanation to cover unobserved actions, the question of how to generate explanations that make use of unobserved actions should also be addressed. An algorithm is described above for building explanations that incrementally processes each of the observations to advance the pending set (as shown by way of example in FIG. 2). This algorithm for generating explanations can be extended to explicitly consider the possibility that actions that were not present in the observation stream were actually executed. Given the assumption that the agent will only engage in actions that contribute to its goals, it can be concluded that even unobserved actions are within the pending set of the observed agent. This conclusion significantly constrains the set of actions that can be executed even if unobserved. Thus, the following algorithm will not consider the possibility of unobserved actions that are inconsistent with the current pending set of the agent.

To produce a complete and covering set of explanations for the observations, explanation generation can be extended to consider the possibility that every action in the pending set may be executed next and not observed. This extension results in a two stage explanation generation algorithm.

At each time step, the algorithm first considers the possibility that each of the actions in the pending set is performed and not observed. Second, following the original algorithm, the new algorithm generates those explanations in which no unobserved action was performed but instead the next action in the observation stream was performed. This treatment will result in a significant expansion of the search space.

Without further mechanisms, the algorithm provided above will not terminate building explanations. While the original algorithm naturally terminates at the end of the observation stream, nothing in the algorithm specification states when the system must stop considering the possibility of still more unobserved actions resulting in ever more unlikely explanations.

To address this issue, the user is required to provide a threshold value that determines how unlikely an explanation the user is willing to accept, relative only to the unobserved actions. Specifically, the algorithm removes any explanation where:

$${{\prod }_{l}}^{L} Pr ( {unobs}_{1} ) < Threshold$$

This thresholding allows the user to specify, for example, a willingness to accept explanations such that x % (where x %, for example, may be ninety percent) of the time the unobserved actions could have been done and not noticed.

Since the algorithm generates explanations incrementally, thresholding the acceptable explanations provides a natural method for limiting the search for explanations, and provides a stopping criteria for the algorithm. At some point the addition of another unobserved action will drive the current explanation below the threshold which will force the addition of unobserved actions to stop. If all of the observations have been explained, this explanation can be kept. If there are still remaining observations, the algorithm should attempt to explain the remainder without considering unobserved actions. If the system is able to explain all of the observations without exceeding the threshold, it also terminates.

The explanation building pseudo-code set out above could be extended to accomplish this version of the algorithm by the addition of a second for-loop inside the loop over the set of observations and after the initialization of ES′ to the empty set. The new loop will iterate over the set of all current explanations in ES and all of the elements of the current pending set. It would create and add to ES′ explanations using each of the elements of the current pending set to extend each of the explanations in ES. Each such explanation would be noted that the foot of the pending set element is not observed. This loop should also only add explanations if the thresholding requirements described above are met.

This approach allows the system to differentially consider actions on the basis of their false negative rates. That is, at the same threshold value, the system considers explanations with more instances of actions that are more likely to have been performed and not observed than actions that are not likely to have been performed and not observed. For example, the system would more easily consider an explanation with multiple stealthy port scans (low probability of observation) than an explanation with even a single unobserved successful denial of service on one of its critical DNS servers (high probability of observation).

Setting a threshold value is effectively a trade off between considering the possibility and number of unobserved actions and the runtime of the algorithm. Three rules can help in setting this value.

First, the algorithm can be run the first time with a threshold high enough to prevent the consideration of unobserved actions. This first run will not only provide a baseline for understanding the runtime of the domain, but will also provide some understanding of the plans that may be identified without partial observability. Subsequent runs can be performed at differing thresholds in order to select a threshold that produces acceptable results in an acceptable amount of time.

Second, an off line analysis of the plan library can reveal helpful settings for the threshold. For example, in the case of a plan that is known to have an action whose execution is not observed ninety percent of the time, the threshold must be set below ninety percent to even consider this plan. This analysis can be generalized for sequences of unobserved actions the user is interested in making sure are considered.

Third, in a similar way, sets of unobserved actions the user would like to rule out can be used to set a lower bound for the threshold.

Two domains of interest are those involving elderly patient assisted living environments and tracking hostile agents in computer network security. Both of these domains require recognizing, and reasoning about, situations in which the agents being observed have abandoned a plan or goal. For example, in the case of an elderly patient who begins the process of taking medication but gets distracted and does not complete the plan, the plan recognition system can provide helpful reminders if it can recognize when that plan has been abandoned and will not be completed. Likewise, in order to avoid being swamped with hypotheses, a computer intrusion tracker must be able to recognize when an attacker has abandoned a particular line of attack and moved on to another.

In general, the ability to infer abandoned goals is an operational requirement for any plan recognition system that is executing incrementally and continuously. Abandoning goals is something that all real world agents will do. If a plan recognition system is unable to recognize this fact, the system will build up an ever increasing set of active or open plans that the agent has no intention of completing. A system attempting to find completions for these open plans will wind up considering unreasonable situations such as the elderly patient who began making a sandwich but did not finish it until several days or even weeks later, or a hacker attempting the first step of a two step plan with a required seconds or minutes duration but not attempting the second step of the plan until days or weeks later.

Unfortunately, existing plan recognition systems cannot draw such inferences. Instead, they have adopted a number of methods to work around the recognition of abandoned goals. For example, some existing plan recognition systems only worry about the agent's current goal. These systems discard previous goals of the agent and do not treat abandoned goals as any different than a simple change in the system's belief about the current goal of the agent. However, in domains where the abandonment of a specific goal may require a response, this approach is unacceptable, such as where it is desired to prompt a user to finish a plan that the user has abandoned.

Some existing plan recognition systems assume that the agent only has one goal. There is often only one goal with which the system is concerned, i.e., the user acquiring a skill or knowledge from the system. For such systems, only those actions that are part of the educational process are relevant for recognition. Behaviors not explainable in terms of the educational goal indicate that the agent's attention has wandered and the system should attempt to refocus the agent on the learning task. However, such an assumption is too strong. In most real world applications, users will have a wide range of possible goals, many (if not all) of which can be abandoned without significant consequences.

Some existing plan recognition systems assume that an agent has not abandoned the goal and instead will always come back to the goal. These systems assume that, while an agent may interrupt one goal in order to achieve another one, they will eventually return to the original goal. Again, this assumption is simply not true for many real world applications.

Some existing plan recognition systems rely on a cooperative agent for disambiguation. These systems expect that agents can be counted upon to communicate that they have abandoned a goal, possibly in response to a direct query from the system. However, such a requirement does place a significant load on the users. Further, it is not clear that users can reasonably be expected to honestly answer such query. Not all users are cooperative.

Recognizing abandoned plans is related to but very different from forgetting plans that have been completed or closed. In fact, making the assumption that a plan has been abandoned is one way of determining that it has been closed and, therefore, might be forgotten (or moved to long term store from working memory).

Finally, some system may draw a distinction between plans that have been abandoned and plans that are being indefinitely postponed. Plans that are being indefinitely postponed can be treated as being abandoned.

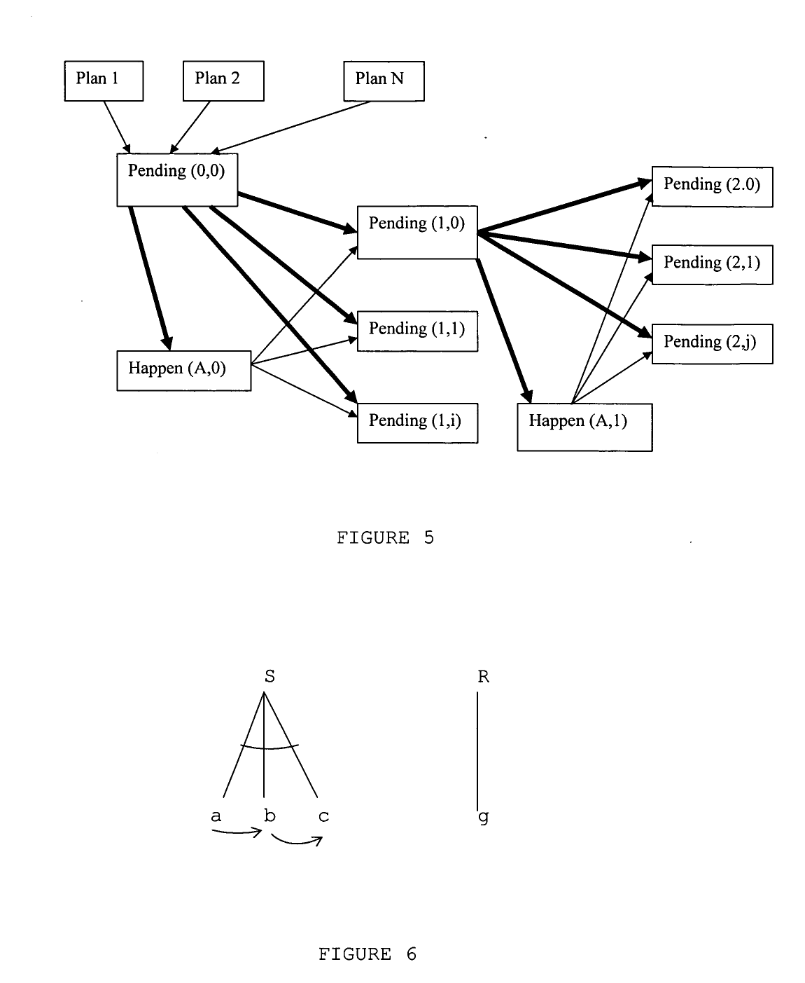

Looking at information provided by pending sets is an important component of plan recognition as described herein. Including plan abandonment in the model of plan execution changes the way in which pending sets are progressed. It may be assumed that, immediately after each action in the observation sequence, the agent is able to abandon one or more of the goals in its pending set. This assumption means that the previous pending set and the action observed no longer uniquely determine the new pending set. When plan abandonment is including in the plan recognition model, the model moves from the one seen in FIG. 2 to that shown in FIG. 5.

The model of pending set progression is no longer deterministic. Previously, a pending set and an action execution yielded a unique pending set for the next time instant. However, now there are multiple possible alternative pending sets. In FIG. 5, these are denoted as Pending(t,0), Pending(t,1), . . . , Pending(t,i), where t represents time. As before, the execution of an action generates a unique new pending set by enabling new actions. However, now the agent also chooses a set (possibly the empty set) of goals to be abandoned resulting in multiple possible pending sets.

Since the agent may abandon more than a single goal at a time, the number of pending sets equals the number of possible subsets of the goals in the pending set that would have resulted without considering abandonment, i.e., the new hypotheses correspond to the power-set of the goals in the original pending set. Thus, where the previous algorithm had to consider a single pending set for n root goals, confronting goal abandonment requires the examination of 2ⁿ pending sets for the next observation with m≦n goals in each. This kind of explosion of the explanation space makes explicitly computing the probability of goal abandonment computationally very expensive.

Instead, rather than explicitly considering all of the possible plans that could be abandoned, goal abandonment can be looked at as a question of model revision. If a model of plan execution does not consider plan abandonment to recognize observation streams in which the agent is abandoning plans, the computed probabilities for the observation streams can be expected to be quite low. It has been suggested that cases of an unexpectedly small probability of the observations given the model P(observations|Model) should be used as evidence of a model mismatch.

In the case where the recognition of a specific kind of model failure (namely that the agent is no longer executing a plan that it has begun) is of interest, the statistic of P(observations|model) is not sufficient. While this statistic will drop rather rapidly as we fail to see evidence of the agent carrying out the steps of their plan, it does not provide sufficient information to determine which of the agent's goals has been abandoned. Therefore, instead of the general P(observations|model) statistic, a more specific statistic can be used.

Let it be assumed that someone who is initially believed to have two high level goals α and β is being observed, that at the outset the agent mostly alternates the steps of the plans, and that at about half way through the agent stops working on β and instead only executes actions that are part of α. As the string of actions that contribute only to α gets longer, and no more actions that contribute to β are observed, it can be suspected that the agent has abandoned β.

These considerations can be formalized as the probability that, for a particular explanation e, none of the subsequently observed actions (e.g., from s to t) contribute to the goal G. This probability can be denoted as follows:
P(notContribₑ(G,s,t)|model,observations)

A probability that gets unexpectedly small is evidence of a mismatch between the model and the real world. That is, the model predicts that the agent is still working on the goal, while the agent may have abandoned it.

The new statistic, abandoned, may be defined as the inverse of the notContribₑ statistic as it corresponds to the probability that a given goal has been abandoned within this particular explanation. This concept is embodied by the following equation:
P(abandonedₑ(G,s,t)|model,observations)=1−P(notContribₑ(G,s,t)|model,observations
As the inverse of notContribₑ, if P(abandonedₑ(G,s,t)|model,observations) gets unexpectedly large, it can be assumed that the goal G has been abandoned in the explanation e.

In computing notContribₑ and abandonedₑ, the very simple plan library shown in FIG. 6 can be considered. The first plan is a very simple plan for achieving S by executing a, b, and c, and the second plan for achieving R has only the single step of g. Given this plan library, the following sequence of observations may be assumed: happen(a,0), happen(b,1), happen(g,2), happen(g,3). In this case, it is known based on these observations and the plan library that, at time 0 and 1, the agent has as a goal of achieving S. If it is assumed that all of the members of the pending set are equally likely to be selected for execution next, the probability of seeing c at time 2 is given by (m/|PS₂|) where m is the number of members in the pending set that have c as the next action. The probability that c will not be seen (that is, the probability that any other member of the pending set is chosen at time 2) is 1-(m/|PS₂|) or, more generally, the probability that b is seen at time (s-1) and c is not seen by time t is given as follows:

$${\prod }_{i = s}^{t} ( 1 - ( m / \vert {PS}_{i} \vert )$$

It is noted that in this case the stream of actions is fully observable. Therefore, the only way for c to leave the pending set is either to be executed or to have the root goal be abandoned. (As before, the uniformity assumption is used for convenience only and is not required.) This expression can be generalized slightly in order to deal with partially ordered plans. With partially ordered plans, it is possible for more than a single next action to contribute to the specified root goal. Thus, if m_{q,i} represents the number of elements (with any next action) in the pending set at time i that contribute to goal q, (s-1) is the last time an action contributed to q, and t is the current time, the above expression may be revised as follows:

$$P ( {notContrib}_{e} ( q , s , t ) \vert model , obs ) = {\prod }_{i = s}^{t} ( 1 - \frac{{m}_{q , , i}}{\vert {PS}_{i} \vert} )$$

Thus, under the assumptions given above, the probability of the subsequence of actions not contributing to a given plan or goal in an explanation can be computed and, thereby, abandonedₑ can be computed.

Under the model revision interpretation, it can be expected that, if the probability of abandonedₑ gets unexpectedly large, the goal can be indicated as abandoned in this explanation. Thus, the user is required to set a threshold for P(abandonedₑ), which we will call the probability of abandonment threshold (or PAT). Any rise in the probability of abandonedₑ above the PAT can be considered as sufficient evidence of a model mismatch and the model can be revised to reflect the goal's abandonment in this explanation. The explanation is revised by removing all elements from the current pending set that contribute to the abandoned goal. The plan execution modeling for the rest of the plans can continue as before. Allowing the user to set the PAT allows the user to explicitly control how much evidence is required before the goal is assumed to be abandoned.

Thus far only the estimation of the probability that a given goal has been abandoned in a particular explanation (set of goals, plans, and pending sets) for the set of observations has been discussed. Estimating the probability that a given goal has actually been abandoned across all explanations requires a further step.

If P(abandonedₑ(g,s,t)|model,obs) is computed for each goal g and the resulting explanations are thresholded as described above, explanations of the observations in which goals have been abandoned can be produced. By considering the complete and covering set of such explanations for the observations, the probability of a specific goal's abandonment can be estimated as given by the following equation:

$$P ( ABANDON ( g ) \vert Obs ) \approx \frac{{{\sum }_{e}}^{{Exp}_{A ( g )}} P ( e \vert Obs )}{{{\sum }_{e}}^{Exp} P ( e \vert Obs )}$$

where Exp represents the set of all explanations for the observations, and EXP_{A(g)} represents the set of explanations in which the goal g is marked as abandoned. It should be kept in mind that, since the individual explanations are compared to the PAT to determine if a particular goal has been abandoned, there is no reason to threshold P(ABANDON(g)|obs).

A single explanation was defined above in a manner that is very similar to a parse tree for context-free grammars (with the addition of pending sets). Conventional context-free grammars for natural language processing are often annotated with features to carry along the extra information that is needed for the parsing of the sentence and to allow for the construction of a structure representing the semantics of the sentence. Such features allow for validating number and tense agreement and other syntactic properties. The plan recognition system described herein makes use of a very similar capability to bind observational arguments and temporal relations between observations.

All the plans that have been discussed above are propositional. However, the plan recognition system described herein does support a limited form of arguments for observations and plans. Rather than supporting a full blown first order representation of plans, variables are closer to simple place holders that support propagation and co-reference, which is very similar to the features like number and case that are sometimes included in context-free grammars for natural language parsing and that are bound at parse time. To do this, the plans within the plan library are augmented with variables and optional type specifications for these variables.

All arguments within a plan are implicitly existentially quantified, and the use of a common name denotes co-reference within a given plan definition. Variable bindings will propagate upwards from their introduction in observations to higher levels of abstraction in the plans.

The following method definition taken from a plan library for a simple domain for recognizing when a child is being taken to school can be considered.

(def-method ′(taking-child-to-school child)

′((put-in-vehicle child vehicle)

(drive-vehicle-to-school vehicle)
(take-from-vehicle child vehicle)
(go-into-school child)

(def-precond 2 ′(1))
(def-precond 3 ′(2))
(def-precond 4 ′(3))
(endm)

The “taking-child-to-school”, action has one argument, child. Further, all of the actions in the decomposition make use of the arguments child and/or vehicle. Both child and vehicle are assumed to denote variables, and all references to the same variable name within a single action definition (root, method, choice, or leaf) are assumed to co-refer.

In building the explanation structure for an specific observation of a put-in-vehicle action, the child and vehicle variables are bound together and the bindings are propagated both up the structure to the “taking-child-to-school” action and to other occurrences of the variables in later actions in the method. To enable this propagation, any arguments to an action are required to occur in at least one of the sub-actions of the original action's definition. If the variable does not occur in a lower level action, it will not be bound by observations and will be left unbound in generated explanations.

Once the variables are bound by observations, later observations with conflicting variable bindings may be inconsistent with the bindings within the explanation, which may mean that some explanations for the observations are discarded. Therefore, correct binding and propagation of variables provide additional constraints on generating explanations consistent with the observations. Thus, this simple form of observation driven variable binding and propagation can result in significant reductions in search space.

With the reductions from inconsistent variable bindings in mind, adding type constraints to variables enables further reductions in the set of consistent explanations. To this end, the variables should allow the specification of the type of object that can be bound to a specific argument. For example, restricting the previous example so that the child could only be bound to a child of school age and so that vehicle could only be bound to cars allows the taking of a new born to school or using an aircraft carrier to go to school to be ruled out.

These considerations results in the following new definition.

(def-method

′(taking-child-to-school (child :type :school-aged))

′((put-in-vehicle (child :type :school-aged)

(vehicle :type :car))

(drive-vehicle-to-school (vehicle :type :car))
(take-from-vehicle (child :type :school-aged))

(vehicle :type :car))

(go-into-school (child :type :school-aged))))

(def-precond 2 ′(1))
(def-precond 3 ′(2))
(def-precond 4 ′(3)
(endm)

Finally, the type system supports simple negation of types to allow a domain designer to specify the type of object that can not be bound to a specific variable. This negation is done through the keyword: not in the type definition and could be used in the previous example to prevent the use of aircraft as follows:

(def-method

(taking-child-to-school (child :type :school-aged))

′((put-in-vehicle (child :type :school-aged)

(vehicle :type :not :aircraft))

(drive-vehicle-to-school

(vehicle :type :not :aircraft))

(take-from-vehicle (child :type :school-aged)

(vehicle :type :not :aircraft))

(go-into-school (child :type :school-aged))))

(def-precond 2 ′(1))
(def-precond 3 ′(2))
(def-precond 4 ′(3))
(endm)

This type negation, when coupled with bottom up binding variables, can be strong. Since variables are initially bound in a specific observation, the observation itself will only ever provide bindings for the arguments that fall within a limited range. This characteristic inherently limits the scope of the argument to a subset of types making type negation much stronger. The case of a drugstore with a drug purchase action defined as follows can be considered:

(def-method

′(buy-drugs (agent :type :elder)

(drug :type :not :prescription))

′((pick-up-drug (agent :type :elder)

(drug :type :not :prescription))

(carry-to-checkout (agent :type :elder)

(drug :type :not :prescription))

(pay (agent :type :elder)

(clerk :type :employee))))

(def-precond 2 ′(1))
(def-precond 3 ′(2))
(endm)

In this case, the observation of a pick-up-drug action is assumed to only have a drug bound to the second argument. Since this binding is carried along by the observation, there is no need to worry about the possibility that the second argument might be a car or a banana. It is already constrained to the family of drugs. Thus, by negating the type prescription, this already limited set of possible bindings is further restricted to the set to non-prescription drugs.

Typed arguments are stored in the plan library in association with the actions that enable the plans.

Like typed arguments to an observation that can be used to rule out possible explanations, temporal constraints can be very effective in pruning possible explanations. Many tasks have simple temporal relations between their subtasks and no plan recognition system should consider explanations that violate these bounds as valid.

A duration constraint captures the overall duration for a single action. For example, most people would not take more than an hour to make lunch. This idea can be coded into the rules for recognizing “normal lunch events,” and if an agent violates this requirement, the plan recognition system should not recognize this as a normal lunch event. It may be that the lunch plan has been abandoned or it may be a special occasion, but in either case the plan recognition system should not consider this action as a normal lunch event. This kind of limitation can be captured by a simple restriction on the definition of the lunch action that requires that it not take longer than an hour to make lunch.

If duration constraints are placed on actions that have sub-actions, this placement can actually force the sub-actions to overlap. For example, in the case of an action that has three sub-actions where the parent action is constrained to take no more than 3 time units, the sub-actions either must be overlapped in time or the explanation is inconsistent if any of the actions takes longer than one time unit.

Inter-sibling temporal constraints constrain the temporal distance between the beginning and/or the end of two sibling actions. For example, in the case of starting a car by turning the ignition key and depressing the gas, if the gas is not depressed within a short proximity of the beginning of the key turning action the car will not start. In this case, a temporal constraint is needed between the start times of the two sibling actions. Again if both of these actions are seen but they are not in the correct temporal relation, no consideration should be given to any explanation of the actions that ascribes them to a car starting goal. By specifying these constraints on the basis of the beginning and/or end times for the actions, for ordered actions, a maximum time duration can be implicitly defined for one or both of the actions. For example, in the case of two siblings α and β that are sequentially ordered, if a constraint is added such that β_{end} must be within 5 time units of α_{begin}, then both α and β must each individually be less than 5 time units and there sum must also less than 5 time units.

Both duration and inter-sibling constraints are representable as follows:
timePoint₁<=timePoint₂+C
where the time points in the case of a duration constraint are the begin time and/or end time of some action, and in the case of an inter-sibling constraint they are the begin time or end time from two actions that are siblings in an action definition. It is this restriction that allows us to enforce that our temporal constraints will form a simple temporal problem (STP) and will, therefore, admit relatively efficient solution.

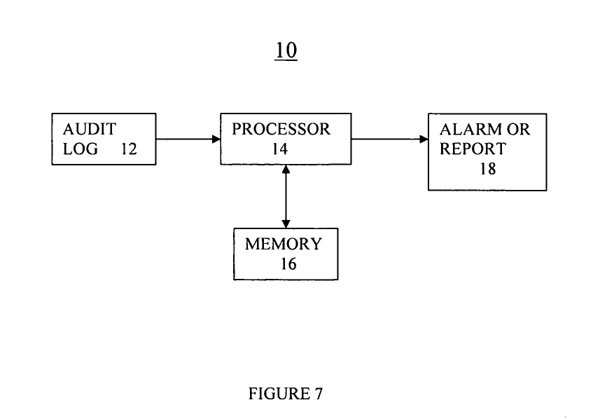

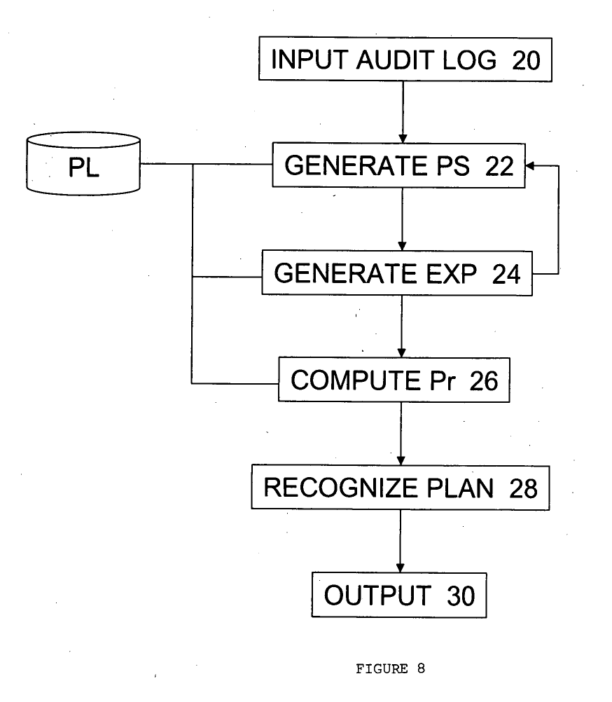

FIG. 7 shows a plan recognition system 10 in which an audit file 12 is input to a processor 14 that operates in accordance with a program stored in a memory 16. The program stored in the memory 16 is described below in relation to a flow chart shown in FIG. 8 and processes the observations contained in the audit log in a manner dependent upon the domain in which the plan recognition system 10 is being used in order to provide an output 18 useful to the user of the plan recognition system 10. This output could be various alarms, various control actions, various reports such as a report of possible plans that the user might want to investigate further, etc.

The memory 16 also stores the plan library, which may be in the form of a database or other data structure, that the program uses during its execution. The plan library stored in the memory 16 may be constructed in accordance with the Definitions 1-5 for a specific domain(s) of interest to the user of the plan recognition system 10. For example, FIG. 1 shows a simple plan library that may be constructed for the computer security domain. More elaborate plan libraries or plan libraries for other domains can be constructed in accordance with these definitions depending upon the desires of the user of the plan recognition system 10.

During execution of the program shown by way of the flow chart of FIG. 8, the audit log 12 is input at 20. At 22 and 24, the plan recognition system 10 loops by first generating a pending set in accordance with Definitions 6 and 7, and by then, on the basis of this pending set and based on the observed actions contained in the audit log 12 and the plans stored in the plan library stored in the memory 16, building a new explanation or extending an existing explanation based on Definition 8 for the observed actions. These explanations are basically plan tree structures extended with the pending sets generated at each time slice, and may be generated in accordance with the type variables and temporal constraints as described above. The process of building a pending set and extending the explanation is iterated until there are no more observations in the audit log 12 or until the probability of unobserved actions drops below a user defined threshold as seen in definition 12.

At 26, the plan recognition system 10 computes a probability for each of the explanations generated at 24 in accordance with Definitions 9-11. Thus, the probability computed for an explanation e is based on the probability given in the plan library for the root goal of explanation e for the observed actions of the agent, the number of alternative rules that could be used to expand a particular one of the J choice points within explanation e, and the number of pending sets of explanations at time k. In essence, this probability indicates the likelihood that the explanation indicates the actual plan of an agent based on the agent's observed actions.

At 28, the plan recognition system 10 selects one or more explanations. For example, only those explanations whose computed probabilities are greater than a selected value may be selected. This selection requires consideration of only those explanations that are deemed to be sufficiently important as determined by the selected value. Alternatively, all explanations can be selected and ranked according to their computed probabilities. This selection permits consideration of all explanations in order of these computed probabilities. As another alternative, only the explanation having the highest computed probability may be selected. This selection requires consideration of only that explanation which is deemed most likely to fit the observed actions.

At 30, the plan recognition system 10 provides the output 18 in the form discussed above.

Certain modifications of the present invention have been discussed above. Other modifications will occur to those practicing in the art of the present invention. For example, a plan library fitting a particular domain is constructed as described above in accordance with Definitions 1-5. Instead, the plan library may be constructed in accordance with other definitions suitable to the chosen domain.

As another example, pending sets are constructed as described above in accordance with Definitions 6 and 7 and explanations are constructed as described above in accordance with Definition 8. Instead, pending sets and explanations may be constructed in accordance with other definitions.

As still another example, probabilities are computed as described above in accordance with Definitions 9-11. Instead, probabilities may be constructed in accordance with other definitions.

Moreover, as described above, plan recognition is based primarily on observed actions of an agent as contained in an audit log. Other factors, however, may be used in plan recognition. For example, as disclosed in U.S. patent applications Ser. Nos. 10/303,223 and 10/348,264 mentioned above, user classification, anomaly detection, and authentication can be used to assist in plan recognition. User classification and anomaly detection continuously monitors a user's actions in order to identify and classify the user based on a learned pattern of actions characterizing the user and based on anomalies in a user' actions. For example, users have typing and pointing styles that involve such characteristics as typing rate, typing rhythm, typing errors, click rate, click rhythm, click errors, etc. Also, users have certain patterns of interaction with computers (such as the order in which applications are usually accessed) that can be learned and associated with corresponding users. User authentication, for example, can involve the use of passive biometrics to identify a user. Such passive biometrics, for example, can include face recognition identification, fingerprint identification, voice recognition identification, and/or stress detection through acoustic, visual and/or infrared sensing. Passive biometrics may also include retina and/or iris scans. Additionally or alternatively, active recognition may be employed for user authentication. For example, the user may be directed to enter a pass word, a personal identification number, personal information, a fingerprint through use of a peripheral device, a signature, hand geometry, etc. Such direction may be random, periodic, and/or directed such as when the plan recognition system 10 determines that a user is suspicious.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claims:

1. A plan recognition method, implemented by a processing system, of recognizing a plan based on observed actions as contained in an audit log comprising:
reading an audit log containing a collection of past observed actions of at least one agent;
based on the observed actions contained in the audit log and a plan library, repeatedly interleaving generation of a pending set of actions that are pending execution by the agent and generation of explanations for the pending actions contained in the pending set;
computing probabilities as to the likelihood that the explanations represent at least one actual plan of the agent; and,
recognizing at least one of the explanations as the actual plan of the agent based on the computed probabilities.

2. The method of claim 1 wherein the generation of a pending set of pending actions based on the observed actions contained in the audit log includes:
comparing the observed actions contained in the audit log with actions contained in plans stored in a plan library; and,
forming the pending sets based on yet-to-be-observed actions corresponding to plans in the plan library that have actions matching the observed actions.

3. The method of claim 2 wherein the plans contained in the plan library are characterized by “and nodes,” “or nodes,” and ordering constraints between actions in the plans stored in the plan library.

4. The method of claim 1 wherein the computing of probabilities comprises computing the probabilities as a function of (i) probabilities associated with root goals of plans corresponding to the generated explanations, (ii) the number of alternative courses of action available to the agent in the generated explanations, and (iii) the number of elements in the generated pending set.

5. The method of claim 4 further comprising storing in the plan library the prior probabilities associated with each of the root goals stored in the plan library.

6. The method of claim 1 wherein the computing of probabilities comprises computing the probabilities as a function of (i) probabilities associated with root goals of plans corresponding to the generated explanations, (ii) the number of alternative courses of action available to the agent in the generated explanations, (iii) the number of elements in the generated pending set, and (iv) probabilities associated with actions that have not been observed but that are consistent with the generated explanations.

7. The method of claim 6 further comprising:
storing in the plan library the prior probabilities associated with each of the root goals stored in the plan library; and,
storing in the plan library the prior probabilities associated with false negatives for observation of the actions stored in the plan library.

8. The method of claim 6 further comprising removing any explanation based on one or more unobserved actions associated whose false negative probability exceeds a predetermined threshold.

9. The method of claim 1 further comprising:
determining when the agent has abandoned a goal; and,
modifying the explanations based on the abandoned goal.

10. The method of claim 9 wherein the modifying of the explanations based in the abandoned goal comprises removing all elements from the pending set that contribute to the abandoned goal.

11. The method of claim 9 wherein the determining of when the agent has abandoned a goal comprises computing a probability that the agent has abandoned a goal g based on (i) a number of elements in a pending set that contribute to the goal g, (ii) a last time s of observing an action contributing to the goal g, (iii) a number of elements in the pending set indexed based on the last time s and a current time t, and (iv) a probability of abandonment threshold.

12. The method of claim 1 wherein the generation of a pending set of pending actions based on the observed actions contained in the audit log includes comparing the observed actions contained in the audit log with actions contained in plans stored in a plan library, and wherein the plans stored in the plan library include argument variables.

13. The method of claim 12 wherein at least one of the variables has a type defined by negation.

14. The method of claim 1 wherein the generation of a pending set of pending actions based on the observed actions contained in the audit log includes comparing the observed actions contained in the audit log with actions contained in plans stored in a plan library, wherein the actions contained in the plans stored in the plan library include temporal constraints between actions.

15. A plan recognition method, implemented by a processing system, of recognizing a plan based on observed actions as contained in an audit log comprising:
reading an audit log containing a collection of observed actions of at least one agent;
comparing the observed actions contained in the audit log to plan actions contained in plans stored in a plan library;
generating explanations for the observed actions based on the comparison of the observed actions to plan actions;
selecting at least one of the explanations as a best fit for the observed actions; and,
providing an output based on the selected explanation.

16. The method of claim 15 wherein the plans contained in the plan library are characterized by “and nodes,” “or nodes,” and ordering constraints between actions in the plans stored in the plan library.

17. The method of claim 15 further comprising removing one of the explanations based on a failure to observe an action that is an element of the removed explanation.

18. The method of claim 15 further comprising:
determining when the agent has abandoned a goal; and,
modifying the explanations based in the abandoned goal.

19. The method of claim 15 wherein the plans stored in the plan library include argument variables.

20. The method of claim 15 wherein the plans stored in the plan library include at least one variable that has a type defined by negation.

21. The method of claim 15 wherein the plan actions contained in the plans stored in the plan library include temporally constrained actions.

22. A computer readable storage medium having program code stored thereon which, where executed, performs the following plan recognition functions:
reading an audit log containing a collection of observed actions of at least one agent;
comparing the observed actions contained in the audit log to plan actions contained in plans stored in a plan library;
generating explanations for the observed actions based on the comparison of the observed actions to plan actions;
computing probabilities as to the likelihood that the explanations explain the observed actions;
based on the computed probabilities, determining at least one actual goal of the agent; and,
providing an output based on the determined goal.

23. The computer readable storage medium of claim 22 wherein the function of computing of probabilities comprises the function of computing the probabilities as a function of probabilities stored in the plan library.

24. The computer readable storage medium of claim 22 wherein the function of computing of probabilities comprises the function of computing the probabilities as a function of actions that have not been observed but that are consistent with the generated explanations.

25. The computer readable storage medium of claim 22 further comprising the functions of:
determining when the agent has abandoned a goal; and,
modifying the explanations based in the abandoned goal.

26. The computer readable storage medium of claim 22 wherein the plans stored in the plan library include argument variables.

27. The computer readable storage medium of claim 22 wherein the plans stored in the plan library include at least one variable that has a type defined by negation.

28. The computer readable storage medium of claim 22 wherein the plan actions contained in the plans stored in the plan library include temporally constrained actions.
